(19) United States
(12) Patent Application Publication
(10) Pub. No.: US 2026/0320329 A1
(43) Pub. Date: Oct. 15, 2026

(54) Techniques for Improving Decoding of Indicia with Small Quiet Zones

(71) Applicant: Zebra Technologies Corporation, Lincolnshire, IL (US)

(72) Inventor: Peizheng Ma, East Setauket, NY (US)

(73) Assignee: Zebra Technologies Corporation, Lincolnshire, IL (US)

(21) Appl. No.: 19/178,364

(22) Filed: Apr. 14, 2025

(51) Int. Cl. G06K 7/14; G06T 7/12

(52) U.S. Cl. CPC G06K 7/1417; G06T 7/12; G06T 2207/20164

(57) ABSTRACT

Techniques for improving decoding of indicia with small quiet zones are disclosed herein. An example method includes attempting to decode an indicia in a first set of image data and, responsive to failing to decode the indicia, receiving an update to a parameter associated with a quiet zone of the indicia. The example method further includes adjusting, based on the update, one or more settings of an indicia locating algorithm. The adjusting may cause the indicia locating algorithm to identify one or more quiet zones of the indicia that are non-compliant with a standard corresponding to quiet zones of the indicia. The example method further includes executing the indicia locating algorithm on a second set of image data with the adjusted one or more settings.

### BACKGROUND

The ability to quickly and accurately identify and decode indicia (e.g., 1-dimensional (1D) and 2-dimensional (2D) barcodes, such as Data Matrix codes) significantly impacts operational efficiency in various sectors, such as retail, logistics, and manufacturing. An important factor in the identification and decoding of such indicia is the presence of quiet zones, which are generally clear margins surrounding the indicia that facilitate the differentiation of the indicia from its surrounding environment. Several specifications require certain minimum sizes for these quiet zones based on the type of indicia being scanned. However, in practice, indicia often do not meet these minimum quiet zone requirements due to printing errors, space constraints, and/or a lack of adherence to specifications by entities generating the indicia. When quiet zones are smaller than expected, scanning devices may struggle to distinguish the indicia from other nearby visual elements, resulting in failed attempts to identify/decode the indicia, causing delays or errors in the underlying operations (e.g., inventory management, product tracking, order fulfillment, etc.).

### SUMMARY

In some aspects, the techniques described herein relate to a method for decoding indicia, including: attempting to decode an indicia in a first set of image data; responsive to failing to decode the indicia, receiving an update to a parameter associated with a quiet zone of the indicia; adjusting, based on the update, one or more settings of an indicia locating algorithm, wherein the adjusting causes the indicia locating algorithm to identify one or more quiet zones of the indicia that are non-compliant with a standard corresponding to quiet zones of the indicia; and executing the indicia locating algorithm on a second set of image data with the adjusted one or more settings.

In some aspects, the techniques described herein relate to a method, further including: successfully decoding the indicia based on executing the indicia locating algorithm on the second set of image data; and responsive to successfully decoding the indicia, automatically re-adjusting the one or more settings of the indicia locating algorithm to identify quiet zones that are compliant with the standard.

In some aspects, the techniques described herein relate to a method, wherein the parameter has a first value corresponding to quiet zones of a first size, a second value corresponding to quiet zones of a second size that is different from the first size.

In some aspects, the techniques described herein relate to a method, wherein the first size is compliant with a standard quiet zone size indicated by the standard, the second size is non-compliant with the standard quiet zone size, and the update indicates a change of the parameter from the first value to the second value.

In some aspects, the techniques described herein relate to a method, wherein the parameter has a third value corresponding to quiet zones of a third size that is different from the first size and the second size, and the method further includes: successfully decoding the indicia based on executing the indicia locating algorithm on the second set of image data; and responsive to successfully decoding the indicia, receiving a second update to the parameter indicating a change of the parameter from the second value to the third value, wherein the third size is larger than the first size and the second size.

In some aspects, the techniques described herein relate to a method, wherein the first set of image data is identical to the second set of image data.

In some aspects, the techniques described herein relate to a method, wherein the one or more settings are associated with at least one of: (i) a step size, (ii) a maximum change value of the step size, (iii) subsampled image data usage, (iv) zoomed image data usage, (v) subpixel analysis, or (vi) an intensity threshold.

In some aspects, the techniques described herein relate to a method, wherein receiving the update to the parameter further includes: (i) receiving, from a host device, the update to the parameter upon connection to a network to which the host device is connected; or (ii) receiving a third set of image data representing a second indicia; and receiving the update to the parameter based on decoding the second indicia.

In some aspects, the techniques described herein relate to a method, wherein the one or more quiet zones of the indicia have a dimension of less than four modules.

In some aspects, the techniques described herein relate to a method, wherein the standard is one of: (i) ISO/IEC 15420, (ii) ISO/IEC 18004, (iii) ISO/IEC 16022, (iv) ISO/IEC 24734, (v) ISO/IEC 24778, (vi) AIMD-DC-2014, (vii) AIMD-014-2008, (viii) ISO/IEC 16023, or (ix) ISO/IEC 20830.

In some aspects, the techniques described herein relate to a method, wherein the indicia locating algorithm is a contour walker algorithm, and the method further includes: executing, based on automatically generated additional points within the first set of image data, the contour walker algorithm to define one or more bounding edges within the first set of image data; and determining a first boundary within the first set of image data from the one or more bounding edges based on one or more heuristics including: (i) bounding edge corner placement, (ii) bounding edge length, or (iii) bounding edge perpendicularity.

In some aspects, the techniques described herein relate to a method, further including: responsive to failing to decode the indicia, generating a parameter adjustment recommendation indicating a recommended adjustment to the parameter; and displaying the parameter adjustment recommendation on a user interface for viewing by a user.

In some aspects, the techniques described herein relate to a system for improving indicia decoding performance, including: one or more processors; and one or more memories communicatively coupled to the one or more processors, the one or more memories storing instructions thereon that, when executed by the one or more processors, cause the system to: attempt to decode an indicia within image data based on a first boundary identified by an indicia locating algorithm; responsive to failing to decode the indicia, receive an update to a parameter associated with quiet zones of the indicia; adjust, based on the update, one or more settings of the indicia locating algorithm, wherein the adjusting causes the indicia locating algorithm to identify one or more quiet zones of the indicia that are non-compliant with a standard corresponding to the quiet zones of the indicia; and execute the indicia locating algorithm on the image data with the adjusted one or more settings to identify a second boundary that is different from the first boundary.

In some aspects, the techniques described herein relate to a system, wherein the instructions, when executed, further cause the system to: successfully decode the indicia based on the second boundary identified by the indicia locating algorithm; and responsive to successfully decoding the indicia, automatically re-adjust the one or more settings of the indicia locating algorithm to identify quiet zones that are compliant with the standard corresponding to the indicia.

In some aspects, the techniques described herein relate to a system, wherein the parameter has a first value corresponding to quiet zones of a first size and a second value corresponding to quiet zones of a second size that is different from the first size, the first size is compliant with a standard quiet zone size indicated by the standard, the second size is non-compliant with the standard quiet zone size, and the update indicates a change of the parameter from the first value to the second value.

In some aspects, the techniques described herein relate to a system, wherein the parameter has a third value corresponding to quiet zones of a third size that is different from the first size and the second size.

In some aspects, the techniques described herein relate to a system, wherein the instructions, when executed, further cause the system to: successfully decode the indicia based on the second boundary identified by the indicia locating algorithm; and responsive to successfully decoding the indicia, receive a second update to the parameter indicating a change of the parameter from the second value to the third value, wherein the third size is larger than the first size and the second size.

In some aspects, the techniques described herein relate to a system, wherein the one or more settings are associated with at least one of: (i) a step size, (ii) a maximum change value of the step size, (iii) subsampled image data usage, (iv) zoomed image data usage, (v) subpixel analysis, or (vi) an intensity threshold.

In some aspects, the techniques described herein relate to a system, wherein the indicia locating algorithm is a contour walker algorithm, and the instructions, when executed, further cause the system to: execute, based on automatically generated additional points within the image data, the contour walker algorithm to define one or more bounding edges within the image data; and determine the first boundary from the one or more bounding edges based on one or more heuristics including: (i) bounding edge corner placement, (ii) bounding edge length, or (iii) bounding edge perpendicularity.

In some aspects, the techniques described herein relate to a tangible machine-readable medium including instructions that, when executed, cause a machine to at least: attempt to decode an indicia within image data based on a first boundary identified by an indicia locating algorithm; responsive to failing to decode the indicia, receive an update to a parameter associated with quiet zones of the indicia; adjust, based on the update, one or more settings of the indicia locating algorithm, wherein the adjusting causes the indicia locating algorithm to identify one or more quiet zones of the indicia that are non-compliant with a standard corresponding to the quiet zones of the indicia; and execute the indicia locating algorithm on the image data with the adjusted one or more settings to identify a second boundary that is different from the first boundary.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an example embodiment of a system of the present disclosure.

FIG. 2A depicts an indicia with small quiet zones represented in image data, in accordance with embodiments described herein.

FIG. 2B depicts the indicia of FIG. 2A after an indicia locating algorithm identifies one or more boundaries corresponding to the indicia within the image data, in accordance with embodiments described herein.

FIG. 2C depicts the indicia of FIG. 2A after adjusting one or more settings of the indicia locating algorithm to identify one or more boundaries corresponding to the indicia, in accordance with embodiments described herein.

FIG. 3 is a first flowchart representative of various methods of decoding indicia, in accordance with embodiments described herein.

FIG. 4 is a second flowchart representative of various methods for decoding indicia, in accordance with embodiments described herein.

FIG. 5 is a block diagram of an example logic circuit for implementing example methods and/or operations described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned, the necessity for quiet zones is a well-established requirement across various types of indicia, including 1D and 2D indicia, such as 1D/2D barcodes. These quiet zones may generally enable scanning devices to discern where an indicia's symbology begins and ends, ensuring accurate and efficient decoding. However, challenges arise when indicia are printed with insufficient quiet zones, which commonly happens due to a range of factors including, e.g., printing errors, space limitations, and/or non-compliance with specifications. This often results in the scanning device being unable to distinguish the indicia from its background, leading to decoding failures and operational inefficiencies in sectors where rapid and accurate identification of items is paramount, such as retail, logistics, and manufacturing.

To address these issues, the present techniques introduce an adjustable parameter that, when adjusted, may correspondingly adjust one or more settings of an indicia locating algorithm configured to locate and/or decode an indicia. This parameter may be adjusted to various values that may correspond to different sizes of quiet zones (e.g., small, medium, or large), enabling fine-tuning of the indicia locating algorithm to accommodate indicia with non-standard quiet zone sizes without compromising the ability to efficiently decode indicia that meet traditional specifications. For example, when the parameter is adjusted to accommodate smaller quiet zones, the systems described herein may correspondingly adjust settings of the indicia locating algorithm that include reducing the allowed maximum jump in pixel steps, avoiding subsampled images, utilizing zoomed images for finer detail, enhancing the intensity threshold for background differentiation, and/or analyzing pixels at greater distances from the current focus to navigate through potential noise. These adjustments may improve the detection and decoding of indicia with minimal/small quiet zones and thereby improve operational efficiency by reducing delays and errors associated with unsuccessful barcode scanning attempts.

Moreover, this adjustable parameter contributes to significant improvements in processing performance of the underlying scanning device. Namely, by specifying an expected size of the quiet zone through the adjustable parameter, the indicia locating algorithm may optimize its processing strategy based on the expected quiet zone size. For example, implementing a smaller step size for the indicia locating algorithm when decoding indicia with smaller quiet zones may enable more precise and efficient boundary detection, leading to enhanced processing accuracy. Conversely, for indicia with standard or larger quiet zones, the systems described herein may employ larger step sizes when executing the indicia locating algorithm, reducing processing time without compromising detection/decoding accuracy. This dual approach ensures that the indicia locating and decoding process is not only more flexible and adaptable to various quiet zone sizes but also more efficient in terms of processing speed and resource usage. Thus, by enabling the indicia locating algorithm to dynamically adjust based on specific requirements, the present techniques provide a comprehensive solution to the challenges posed by non-standard indicia quiet zone sizes, significantly enhancing operational efficiency and user experience in environments where quick and accurate barcode scanning is essential.

In accordance with the above, and with the disclosure herein, the present disclosure includes improvements in computer functionality or in improvements to other technologies at least because the present disclosure describes that, e.g., imaging devices and/or other indicia decoding systems, and their related various components, may be improved or enhanced with the disclosed techniques. That is, the present disclosure describes improvements in the functioning of an indicia decoding system at least because the disclosed techniques introduce an adjustable parameter that dynamically optimizes the indicia locating algorithm, accommodating various sizes of quiet zones that may not adhere to the corresponding standards, resulting in enhanced decoding precision, improved operational efficiency, and an overall superior performance in barcode scanning. This improves upon previous indicia decoding systems at least because such previous systems were limited in their ability to accommodate varied sizes of quiet zones, particularly those that did not comply with the applicable standards, often resulting in suboptimal decoding performance and reduced operational efficiency.

In addition, the present disclosure includes applying various features and functionality, as described herein, with, or by use of, a particular machine, e.g., a scanning device and/or other hardware components as described herein.

Moreover, the present disclosure includes specific features that demonstrate, in various embodiments, particular useful applications, e.g., responsive to failing to decode an indicia, receiving an update to a parameter associated with a quiet zone of the indicia; adjusting, based on the update, one or more settings of an indicia locating algorithm, wherein the adjusting causes the indicia locating algorithm to identify one or more quiet zones of the indicia that are non-compliant with a standard corresponding to quiet zones of the indicia; and/or executing the indicia locating algorithm on a second set of image data with the adjusted one or more settings, among others.

While described herein primarily in the context of imaging devices, the techniques described herein may apply to any suitable devices in any suitable field(s).

As referenced herein, a “quiet zone” is generally an area around an indicia that provides a searching algorithm sufficient contrast to identify where an indicia is located within captured image data. The term “module” may generally describe a single cell in a matrix symbology used to encode one bit of data. For example, the module in a Data Matrix may correspond to a square shape, whereas in a 1D barcode, the module may be the width of a single bar or space within the barcode.

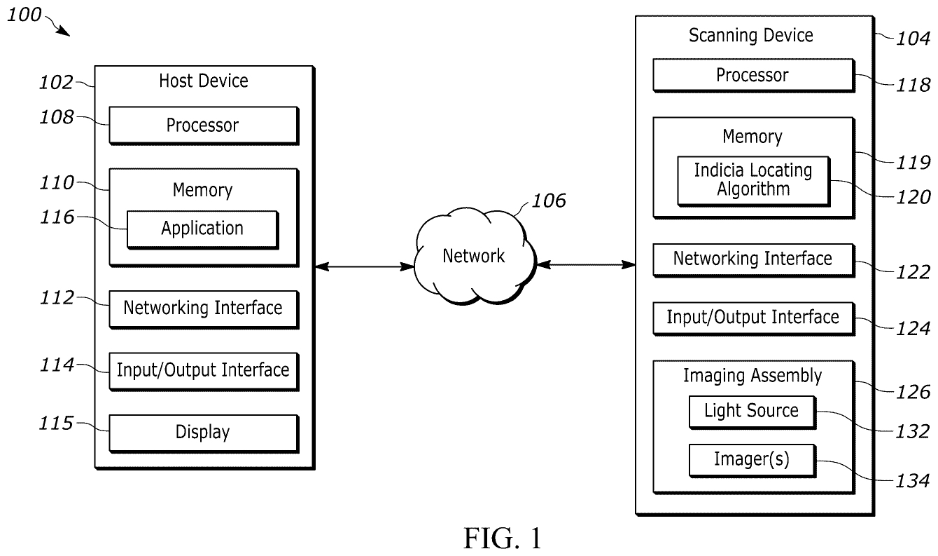

Turning to the drawings, FIG. 1 is a diagram illustrating an example embodiment of a system 100 of the present disclosure. In the example embodiment of FIG. 1, the system 100 includes a host device 102 and a scanning device 104 communicatively coupled to the host device 102 via a network 106. Generally speaking, the host device 102 and/or the scanning device 104 may be capable of executing instructions to, for example, implement operations of the example methods described herein, as may be represented by the flowcharts of the drawings that accompany this description.

The host device 102 is generally configured to act as a central control unit that communicates with the scanning device 104 over the network 106 to, e.g., identify and/or push parameter adjustments to the device 104 and/or transmit data associated with decoded indicia to the device 104. When adjustments to one or more imaging settings become necessary, the host device 102 may identify the specific scanning device 104 that is configured for indicia detection and decoding and may push the required parameter adjustments or instructions to the scanning device 104, typically through a dedicated software application 116 or a command sent over the network 106.

The scanning device 104 may generally be a device configured to capture image data that may include an indicia (e.g., 1D/2D barcodes, etc.) to be detected and decoded. The scanning device 104 may include an indicia locating algorithm 120 in memory 119, which may be executed by the processor 118 to detect the presence and location of various indicia within the captured image data. By analyzing the characteristics of the captured image data, such as patterns and structures, the algorithm 120 may identify the indicia, enabling precise localization for further processing. Once the indicia is/are located and detected by the algorithm 120, the scanning device 104 may utilize decoding software and/or other specialized algorithms (e.g., not shown in memory 119) to extract the encoded information from the detected indicia. This may generally involve interpreting the arrangement, encoding patterns, and/or dot matrix structures of the indicia to accurately decode the data contained within. The scanning device 104 may then provide the decoded information for immediate use or transfer it to a connected device (e.g., host device 102) for further processing and analysis.

As part of this interoperability between the host device 102 and the scanning device 104, the scanning device 104 may receive parameter updates from the host device 102 through the network 106 and may implement the changes to the one or more settings corresponding to the parameter updates. The parameter updates in this context may relate to a parameter associated with quiet zones of an indicia, and when the host device 102 transmits the parameter updates/changes to the scanning device 104, the update may correspond to changes for one or more specific imaging settings of the scanning device 104 that influence the successful detection and decoding of indicia.

For example, a user may input an adjustment (e.g., at the host device 102) regarding the quiet zone parameter, indicating that the quiet zone(s) of the indicia to be detected and decoded are smaller than normal. The host device 102 may receive this input and transmit an indication to the scanning device 104 that the quiet zone parameter has been adjusted from a “regular” value/state to a “small” value/state, such that the setting adjustments corresponding to this change in parameter value/state should be implemented on the device 104. In response, the scanning device 104 may adjust one or more settings associated with an indicia locating algorithm 120 that is configured to locate/detect an indicia in captured image data. These settings may include factors such as a step size of the algorithm when locating the indicia, a maximum change value of the step size, a subsample image data usage value, a zoomed image data usage value, a subpixel analysis value, an intensity value or threshold, and/or any other configurable settings included as part of the indicia detection algorithm 120 or combinations thereof. In certain embodiments, the settings may also include imaging settings associated with the function of the imaging assembly 126, such as a focus value, a contrast value, a scanning speed value, and/or any other suitable settings or combinations thereof.

Accordingly, adjustments to the quiet zone parameter may have significant effects on the settings of the indicia locating algorithm 120, resulting in potential tradeoffs between accurately detecting and decoding indicia with smaller quiet zones and efficiently decoding indicia with larger quiet zones. For example, a user may input an adjustment at the host device 102, indicating that the quiet zones of an indicia to be detected/decoded are smaller than normal. The host device 102 may communicate this adjustment to the scanning device 104, specifying the change in the quiet zone parameter. The scanning device 104 may then modify the corresponding settings associated with the indicia locating algorithm 120, such as by decreasing the step size of the algorithm 120 from three pixels to one pixel. This step size adjustment may enable the algorithm 120 to more accurately determine the boundaries of the indicia by more precisely determining which portions of the image data constitute quiet zones. In this manner, the quiet zone parameter updating described herein may enable the scanning device 104 to accurately detect and decode indicia that have quiet zones that are smaller/larger than normal. In fact, the techniques described herein may enable the scanning device 104 to reliably detect and decode indicia that have quiet zones that fail to satisfy standardized minimum size requirements (e.g., ISO/IEC 15420, 18004, 16022, 16023, 20830, 24734, 24778, AIMD-DC-2014, and/or AIMD-014-2008). In this manner, the present techniques enable the accurate and reliable detection and decoding of indicia that fail to comply with the relevant standards (referenced herein as “non-compliant indicia” having “non-compliant quiet zones), which existing techniques may struggle to detect entirely.

However, reducing the step size (or other settings adjustments) may slow down the scanning device's 104 processing. In the previous example, the processor 118 may need to perform three processing cycles to move three pixels within the image data as opposed to performing a single processing cycle to move three pixels with the prior, larger step size, thereby sacrificing efficiency. To avoid these processing bottlenecks, and in certain embodiments, the scanning device 104 and/or the host device 102 may automatically re-adjust the quiet zone parameter from its adjusted state/value (e.g., “small”) to a normal/regular state after successfully detecting and decoding an indicia utilizing the adjusted state/value of the quiet zone parameter. The scanning device 104 may thereafter execute the indicia locating algorithm 120 with settings corresponding to the normal/regular state of the quiet zone parameter, thereby alleviating any temporary reductions in indicia detection/decoding efficiency that may be sacrificed to detect/decode non-compliant indicia.

By remotely controlling the scanning device's 104 imaging settings, the host device 102 may ensure that the device 104 remains calibrated and properly adjusted for efficient identification and decoding of indicia. However, in certain embodiments, the scanning device 104 may receive parameter updates via some other method, such as through scanning an indicia that encodes the relevant settings adjustment information associated with an adjustment to the relevant parameter. For example, a user may recognize that an indicia to be scanned has quiet zones that are substantially larger than those of a prior indicia that was scanned and decoded by the scanning device 104. The user may thus utilize the scanning device 104 to scan an indicia associated with adjusting a quiet zone parameter from a “small” value/state to a “large” value/state to expedite the detection and decoding of the indicia having large quiet zones. Once decoded, the scanning device 104 may incorporate the settings changes indicated by the data, such that subsequent analysis performed by the indicia locating algorithm 120 may proceed more rapidly than when operating in accordance with the settings corresponding to the “small” value/state of the quiet zone parameter without sacrificing indicia detection reliability.

More generally, the host device 102 may comprise one or more operator workstations, and may include one or more processors 108, one or more memories 110, a networking interface 112, an input/output (I/O) interface 114, a display 115, and an application 116. The application 116, when executed by the one or more processors 108, may configure the one or more processors 108, 118 to perform various functions described herein related to real-time and on-device (e.g., on the scanning device 104) updating of indicia locating algorithm 120 parameters to improve indica detection and decoding performance. For example, the application 116, when executed by the one or more processors 108, may configure the one or more processors 108 to transmit a parameter update via the networking interface 112 to the scanning device 104 that causes the one or more processors 118 to update one or more settings of the indicia locating algorithm 120 stored in memory 119.

The scanning device 104 may generally be a handheld scanning device, a point of sale (POS) scanning device, and/or any other suitable device configured to capture data associated with indicia. The scanning device 104 may capture the image data via an imaging assembly 126 and may include flash memory as part of the one or more memories 119 used for storing or otherwise processing imaging data/datasets and/or post-imaging data. The scanning device 104 may receive, recognize, and/or otherwise interpret a trigger that causes the imaging assembly 126 to capture an image of an object that may include or be associated with an indicia. Once captured, the scanning device 104 may analyze or store the images and any associated data, and/or may transmit the images and any associated data via the network 106 to the host device 102 for further analysis and/or storage. In various embodiments, the scanning device 104 may be a “smart” camera and/or may otherwise be configured to automatically capture and analyze image data in accordance with machine vision job scripts.

In any event, the scanning device 104 may include one or more processors 118, one or more memories 119 having the indicia locating algorithm 120 stored thereon, a networking interface 122, an I/O interface 124, and an imaging assembly 126 having a light source 132 (e.g., a laser) and imager(s) 134. The imaging assembly 126 may include one or more light sources 132 (e.g., one or more lasers or light emitting diodes (LEDs)) for projecting laser light or LED light onto an object and imager(s) 134 (e.g., a digital camera, image sensors, and/or digital video camera) for capturing or taking digital images and/or frames. Each image may comprise pixel data, vector information, or other image data that may be analyzed in accordance with the instructions included in the indicia locating algorithm 120 and/or other indicia decoding software (not shown). For example, the imaging assembly 126 may include a photo-realistic camera (not shown) for capturing, sensing, or scanning 2D image data. The photo-realistic camera may be an RGB (red, green, blue) based camera for capturing 2D images having RGB-based pixel data. Moreover, in various embodiments, the imaging assembly 126 may be configured to capture other sets of image data in addition to the 2D image data, such as grayscale image data or amplitude image data.

Each of the one or more memories 110, 119 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., application 116, indicia locating algorithm 120, or other computing instructions described herein) may be stored on a computer usable (e.g., readable) storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 119) to facilitate, implement, or perform the machine readable instructions, methods, processes, elements or limitations, as illustrated, depicted, or described for the various flowcharts, illustrations, diagrams, figures, and/or other disclosure herein.

In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.). The application 116 and/or the indicia locating algorithm 120 may also be implemented as or as part of a suite of distinct applications in other examples. Those skilled in the art will appreciate that the functionality implemented by the one or more processors 108, 118 via the execution of the application 116 and/or the indicia locating algorithm 120 may also be implemented by one or more specially designed hardware and firmware components, such as field-programmable gate arrays (FPGAs), application-specific integrated circuits (ASICs) and the like in other embodiments.

The one or more memories 110, 119 may store an operating system (OS) (e.g., Microsoft Windows, Linux, Unix, etc.) capable of facilitating the functionalities, apps, methods, or other software as discussed herein. The one or more memories 110 may also store the application 116, which may be configured to enable indicia locating algorithm 120 parameter adjustments, as described further herein. The one or more memories 119 may also store the indicia locating algorithm 120, which may be configured to enable indicia detection and subsequent decoding regardless of quiet zone size, as described further herein. Additionally, or alternatively, the application 116 may also be stored in the one or more memories 119 of the scanning device 104, and/or in an external database (not shown), which is accessible or otherwise communicatively coupled to the host device 102 via the network 106.

The one or more memories 110, 119 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, an imaging application, such as the application 116, where each may be configured to facilitate their various functionalities discussed herein. It should be appreciated that one or more other applications may be envisioned and that are executed by the one or more processors 108, 118.

The one or more processors 108, 118 may be connected to the one or more memories 110, 119 via a computer bus responsible for transmitting electronic data, data packets, or other electronic signals to and from the one or more processors 108, 118 and one or more memories 110, 119 to implement or perform the machine readable instructions, methods, processes, elements or limitations, as illustrated, depicted, or described for the various flowcharts, illustrations, diagrams, figures, and/or other disclosure herein. The one or more processors 108, 118 may interface with the one or more memories 110, 119 via the computer bus to execute the operating system (OS). The one or more processors 108, 118 may also interface with the one or more memories 110, 119 via the computer bus to create, read, update, delete, or otherwise access or interact with the data stored in the one or more memories 110, 119 and/or external databases (e.g., a relational database, such as Oracle, DB2, MySQL, or a NoSQL based database, such as MongoDB). The data stored in the one or more memories 110, 119 and/or an external database may include all or part of any of the data or information described herein, including, for example, indicia images (e.g., images captured by the scanning device 104 featuring or otherwise indicating an indicia to be detected and decoded) and/or other suitable information.

The networking interfaces 112, 122 may be configured to communicate (e.g., transmit and receive) data via one or more external/network port(s) to one or more networks or local terminals, such as network 106, described herein. In some embodiments, networking interfaces 112, 122 may include a client-server platform technology such as ASP. NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 119 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to the network 106. In some embodiments, the network 106 may comprise a private network or local area network (LAN) utilizing Gigabit Ethernet. Additionally or alternatively, the network 106 may comprise a public network such as the Internet. In some embodiments, the network 106 may comprise routers, wireless switches, or other such wireless connection points communicating to the host device 102 (via the networking interface 112) and the scanning device 104 (via networking interface 122) via wireless communications based on any one or more of various wireless standards, including by non-limiting example, IEEE 802.11a/b/c/g (WIFI), the BLUETOOTH® standard, or the like.

The I/O interfaces 114, 124 may include or implement operator interfaces configured to present information to an administrator or operator and/or receive inputs from the administrator or operator. An operator interface may provide a display screen (e.g., via the user host device 102 and/or scanning device 104) which a user/operator may use to visualize any images, graphics, text, data, features, pixels, objects, surfaces, and/or other suitable visualizations or information. For example, the host device 102 and/or scanning device 104 may comprise, implement, have access to, render, or otherwise expose, at least in part, a graphical user interface (GUI) for displaying images, graphics, text, data, features, pixels, and/or other suitable visualizations or information on the display screen (e.g., via display 115). The I/O interfaces 114, 124 may also include I/O components (e.g., connectors, ports, capacitive or resistive touch sensitive input panels, keys, buttons, lights, LEDs indicating one or more of a status of power, light source, or network speed, any number of keyboards, mice, USB drives, optical drives, screens, touchscreens, etc.), which may be directly/indirectly accessible via or attached to the host device 102 and/or the scanning device 104. According to some embodiments, an administrator or user/operator may access the host device 102 and/or scanning device 104 via their respective I/O interfaces 114, 124 to review images or other information, make parameter/setting changes or updates, input responses and/or selections, and/or perform other functions.

As described above herein, in some embodiments, the host device 102 and/or the scanning device 104 may perform the functionalities as discussed herein as part of a “cloud” network or may otherwise communicate with other hardware or software components within the cloud to send, retrieve, or otherwise analyze data or information described herein. For example, the host device 102 may be implemented as one or more cloud-based servers that may comprise one or more cloud-based computing platform(s), such as MICROSOFT AZURE, AMAZON AWS, or the like.

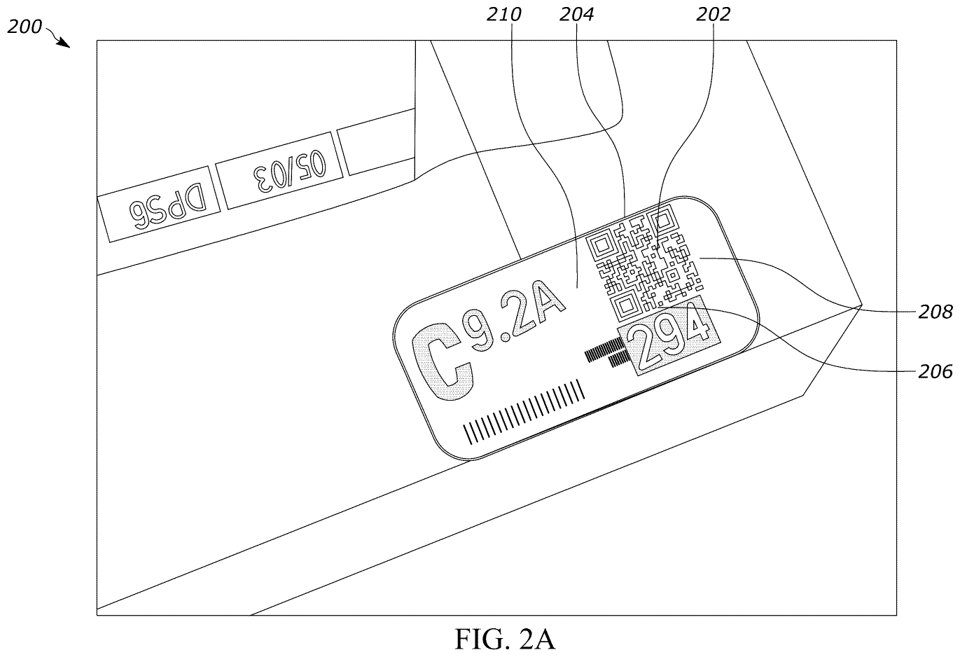

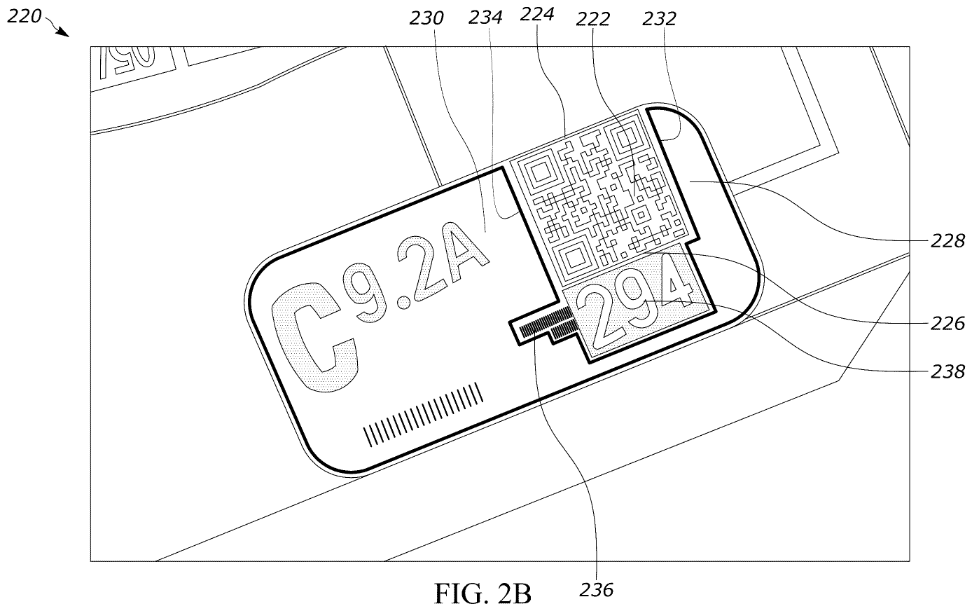

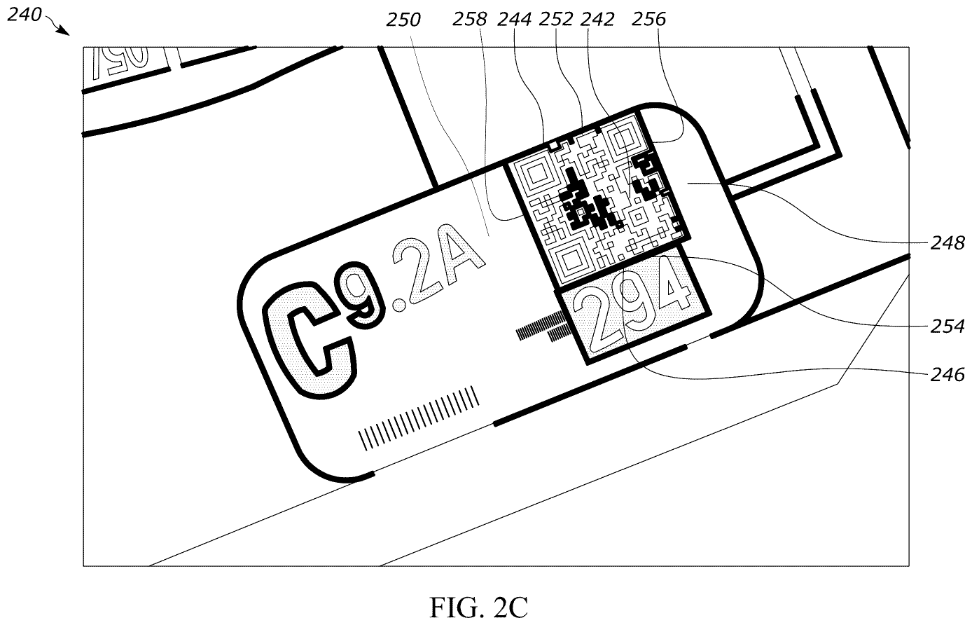

FIG. 2A depicts an indicia with small quiet zones represented in image data, in accordance with embodiments described herein. The image data 200 generally represents a portion of a package that includes an indicia 202 printed as part of a label having other printed material. The indicia 202 has four quiet zones 204, 206, 208, and 210, where the first and second quiet zones 204, 206 are significantly smaller than the third and fourth quiet zones 208, 210.

In particular, the first quiet zone 204 and the second quiet zone 206 may be smaller than the minimum size required by the standard specifying such dimensions of the indicia 202. Both the first quiet zone 204 and the second quiet zone 206 may be too small, such that a scanning device analyzing this image data 200 using existing techniques may be unable to accurately identify the first quiet zone 204 and the second quiet zone 206. Consequently, the scanning device analyzing this image data 200 using the existing techniques may be unable to detect the indicia 202 and thereby unable to decode the indicia 202. However, utilizing the techniques of the present disclosure, the scanning device analyzing this image data 200 may reliably and accurately identify each of the first quiet zone 204, the second quiet zone 206, the third quiet zone 208, and the fourth quiet zone 210 to thereafter detect and decode the indicia 202.

To illustrate, FIG. 2B depicts the indicia of FIG. 2A after an indicia locating algorithm identifies one or more boundaries corresponding to the indicia within the image data, in accordance with embodiments described herein. In the image data 220 illustrated in FIG. 2B, the indicia locating algorithm may utilize settings in accordance with a quiet zone parameter that is configured for “normal” or “large” quiet zones. For the purposes of discussion, the indicia locating algorithm may be a contour walker algorithm generally configured to identify potential contours or boundaries of objects within the image data 220, such as an indicia 222. Specifically, the contour walker algorithm may cause the scanning device to analyze regions of contrast and/or changes in intensity within the image data 220 that may indicate the presence of the indicia 222. The algorithm may then follow these contours and examine their shape, size, and/or other characteristics to determine if they correspond to the expected features of the indicia 222. Thus, by traversing and analyzing the resulting contours determined by the contour walker algorithm, the scanning device may identify and extract the relevant information required for decoding or processing the indicia 222.

It should be appreciated that the terms “normal,” “small,” “large,” and/or the like, when applied to the quiet zone parameter may generally reference the size of the corresponding quiet zones. Further, while generally discussed herein in terms of having “small,” “normal” and/or “large” states/values, it should be understood that the quiet zone parameter may have any suitable number and/or classification of states/values. For example, the quiet zone parameter may have five separate states/values that each correspond to increasing sizes of quiet zones. As another example, the quiet zone parameter may have multiple sets comprising “small,” “normal,” and “large” states/values for multiple, different indicia types, including a set for 1D barcodes and a separate set for 2D barcodes, such as Data Matrix codes, etc.

In the example of FIG. 2B, the contour walker algorithm may analyze the image data 220 using the settings associated with the “normal” or “large” quiet zone parameter and may determine several contours 232, 236, and 234 that may be associated with various objects indicated in the image data 220. However, not all of these objects are or are associated with the indicia 222. For example, while the first contour 232 and the second contour 234 may generally be associated with the indicia 222, the third contour 236 is not associated with the indicia 222. Instead, the third contour 236 is more closely associated with the non-indicia object 238 (e.g., the graphic indicating “294” and associated text) below the indicia 222. Thus, while the contour walker algorithm may have identified two contours associated with the indicia 222, corresponding to the third quiet zone 228 and the fourth quiet zone 230, the contour walker algorithm did not identify contours associated with the other two quiet zones 224, 226.

In certain instances, this failure by the contour walker algorithm may be attributed to the indicia having non-conforming quiet zones (e.g., zones 224, 226), such that the settings of the algorithm do not enable their detection. Namely, the contour walker algorithm settings corresponding to the “normal” state/value of the quiet zone parameter may be configured to enable the contour walker algorithm to efficiently and accurately detect indicia with conforming quiet zones and may thereby be non-optimal or insufficient to detect indicia with non-conforming quiet zones. For example, the first quiet zone 224 and the second quiet zone 226 may not include sufficient space between the adjacent edges of the indicia 222 and another object (e.g., non-indicia object 238) and/or a large enough area of sufficient/consistent contrast (e.g., transition from the label to the box above the first quiet zone 224), as defined in the relevant standard(s). When executed by the scanning device, the contour walker algorithm may thus erroneously skip determining contours associated with the top of the indicia 222 in the first quiet zone 224 and the bottom of the indicia 222 in the second quiet zone 226 (e.g., between the indicia 222 and the non-indicia object 238).

To alleviate these issues, the scanning device and/or the host device may adjust or cause adjustments to the settings of the indicia locating algorithm based on corresponding adjustments to the quiet zone parameter. In the example of FIG. 2B, the first quiet zone 224 and the second quiet zone 226 are non-conforming, small quiet zones, such that the quiet zone parameter should be adjusted from a “normal” state/value to a “small” state/value. This adjustment may result in the scanning device adjusting one or more settings of the indicia locating algorithm to more optimally detect indicia with non-conforming, smaller indicia, such as by reducing the step size, increasing the intensity threshold used to distinguish the indicia from the background, and/or allowing the use of zoomed in images from the image data for subpixel walking (e.g., when defining contours). The results of such parameter and settings adjustments are illustrated in FIG. 2C, which depicts the indicia of FIG. 2A after adjusting one or more settings of the indicia locating algorithm to identify one or more boundaries corresponding to the indicia, in accordance with embodiments described herein.

The image data 240 of FIG. 2C includes the indicia 242 with four quiet zones 244, 246, 248, and 250, two of which (first quiet zone 244 and second quiet zone 246) are non-conforming, small quiet zones. When the scanning device adjusts the one or more settings of the indicia locating algorithm based on the adjustment/update to the quiet zone parameter, the indicia locating algorithm may again attempt to determine one or more contours or boundaries that may enable detection and decoding of the indicia 242. While described herein primarily in terms of a contour walker algorithm that determines contours, it should be appreciated that any other suitable algorithms may be used in accordance with the techniques described herein.

In certain embodiments, the example of FIG. 2C may represent a subsequent execution of the indicia locating algorithm after the contours identified in the image data 220 of FIG. 2B resulted in a failure to decode the indicia 222. The scanning device and/or host device may receive an update to the quiet zone parameter and may cause corresponding adjustments to the settings of the algorithm, which when re-executed, may output the set of contours 252, 254, 256, and 258 illustrated in FIG. 2C. It should also be appreciated that the image data analyzed in the example of FIG. 2C may be the same or different from the image data analyzed in the example of FIG. 2B.

Each of the first contour 252, the second contour 254, the third contour 256, and the fourth contour 258 may represent a boundary/edge of the indicia 242 because the adjusted settings based on the quiet zone parameter update enable the indicia locating algorithm to correctly identify each of the quiet zones 244, 246, 248, and 250 associated with the indicia 242. For example, by reducing the step size from three pixels to one pixel, the indicia locating algorithm may more methodically analyze the region representing the bottom edge of the indicia 242 and not avoid the second quiet zone 246 to thereby determine the second contour 254. Similarly, when the indicia locating algorithm reaches the top of the indicia 242, the algorithm may not avoid the first quiet zone 244 to thereby determine the first contour 252.

In certain embodiments, the indicia locating algorithm may initiate execution on the image data 240 at a location (e.g., center of indicia 242) based on a set of additional points (not shown) generated within the image data 240. The indicia locating algorithm may then proceed through the image data 240 to define one or more bounding edges within the image data 240, represented by the first contour 252, the second contour 254, the third contour 256, and/or the fourth contour 258. The indicia locating algorithm and/or any other suitable component(s) described herein may then determine a boundary within the image data 240 from these bounding edges. For example, the algorithm or other suitable component(s) may determine that the first, second, third, and fourth contours 252-258 define a first boundary, respectively (e.g., boundary around the indicia 242). The algorithm or other suitable component(s) may utilize one or more heuristics to make these boundary determinations, such as whether the bounding edge corner placement, the bounding edge length, and/or the bounding edge perpendicularity is similar enough to the expected placement, length, and/or perpendicularity of a true boundary.

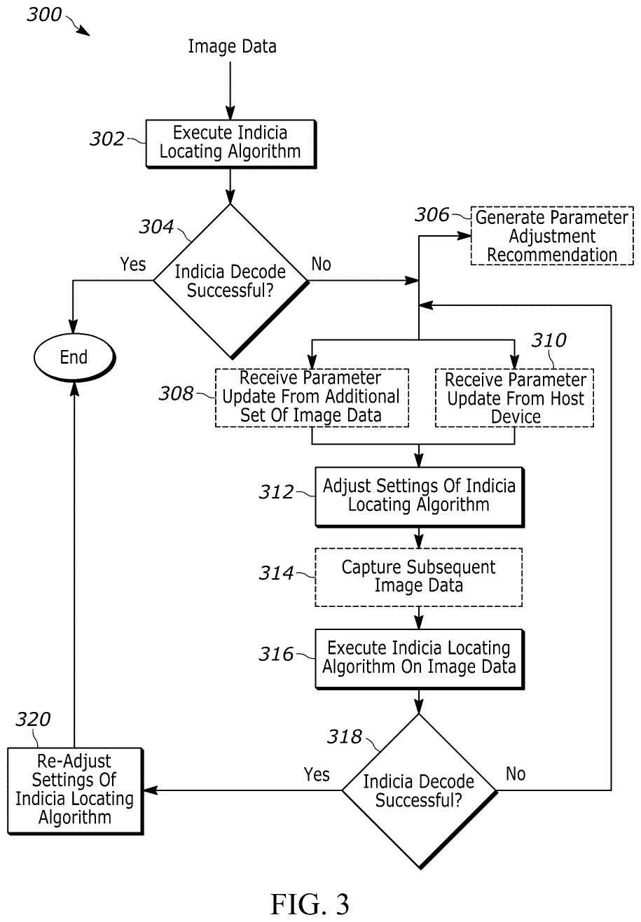

FIG. 3 is a first flowchart representative of a method 300 for decoding indicia, in accordance with embodiments described herein. It is to be understood that any of the steps of the method 300 may be performed by, for example, the scanning device 102, and/or any other suitable components, components contained therein, and/or combinations thereof discussed herein.

At block 302, the method 300 includes receiving image data and executing an indicia locating algorithm to detect any indicia that may be indicated/represented within the image data. Based on the contours, boundaries, and/or other distinguishing features output by the indicia locating algorithm that may enable the scanning device to detect the indicia, the scanning device may thereafter attempt to detect and decode the indicia (block 304). If the scanning device is successful in decoding the indicia (Yes branch of block 304), the method 300 may terminate.

However, if the scanning device is unsuccessful in decoding the indicia (No branch of block 304), the method 300 may further include one or more optional steps. Tn certain embodiments, the method 300 may include generating a parameter adjustment recommendation for display to a user (block 306). For example, the recommendation may indicate, based on the outputs of the indicia locating algorithm, whether any indicia included in the image data are likely to have conforming or non-conforming quiet zones. If the scanning device determines that the quiet zones that are apparently present within the image data are likely to have non-conforming quiet zones, the scanning device may generate and output a recommendation indicating to the user that the quiet zones are likely non-conforming and that the user should adjust the quiet zone parameter from a “normal” state/value to a “small” state/value to maximize the potential for successful detection and decoding in a subsequent execution of the indicia locating algorithm and corresponding decoding software.

In some embodiments, the method 300 may include receiving a parameter update from an additional set of image data (block 308) or from a host device (block 310). As mentioned, the scanning devices described herein may receive parameter updated in a variety of manners, such as pushed from a host device (e.g., host device 102) through a network and/or via scanning a separate indicia storing information associated with the relevant parameter update. Thus, at block 308, the method 300 may include the user using the scanning device to capture image data of a parameter update indicia that the scanning device may subsequently detect (e.g., via indica locating algorithm) and decode to receive the quiet zone parameter update information. Additionally, or alternatively, at block 310, a host device (e.g., host device 102) may push the relevant quiet zone parameter update to the scanning device across a network (e.g., network 106).

Regardless, when the scanning device receives the quiet zone parameter update, the scanning device may proceed to adjust one or more settings of the indicia locating algorithm (block 312). For example, if the quiet zone parameter update indicates an adjustment from the “normal” or “small” state/value to the “large” state/value, then the scanning device may update the step size from one or three pixels to five pixels and may reduce the intensity threshold used to distinguish the indicia from the quiet zones. In certain embodiments, after adjusting the settings in response to the updated quiet zone parameter, the method 300 may optionally include the scanning device capturing a subsequent image dataset (block 314). The subsequent image dataset may include a representation of the indicia that was represented in the image data received at block 302.

Whether analyzing a new image dataset of the same indicia or re-analyzing the same image dataset received at block 302, the method 300 may further include executing the indicia locating algorithm on the image data (block 316). The scanning device may thereby again attempt to detect the indicia within the image data (block 318). If the scanning device fails to detect and/or decode the indicia (No branch of block 318), then the method 300 may revert back to the No branch of block 304. In other words, if the scanning device subsequently fails to detect and decode the indicia, it is possible that another adjustment to the quiet zone parameter may be required. Accordingly, the scanning device may output another recommendation and/or receive another update to the quiet zone parameter to iteratively re-attempt to detect and decode the indicia until the scanning device is successful at detecting and decoding the indicia.

If the scanning device successfully detects and decodes the indicia (Yes branch of block 318), the method 300 may include re-adjusting the settings of the indicia locating algorithm to values corresponding to a “normal” state/value of the quiet zone parameter (block 320). As mentioned, adjusting the settings of the indicia locating algorithm to more optimally detect indicia having non-conforming (e.g., small) quiet zones may negatively impact certain aspects of algorithm execution, such as processing efficiency, without gaining significant improvements in detection rates for indica having conforming quiet zones. Thus, the scanning device may automatically re-adjust the indicia locating algorithm settings from the “small” (or “large” or any other setting) to the “normal” settings after the indicia having non-conforming quiet zones is/are detected and successfully decoded.

Of course, it is to be appreciated that the actions of the method 300 may be performed any suitable number of times, and that the actions described in reference to the method 300 may be performed in any suitable order.

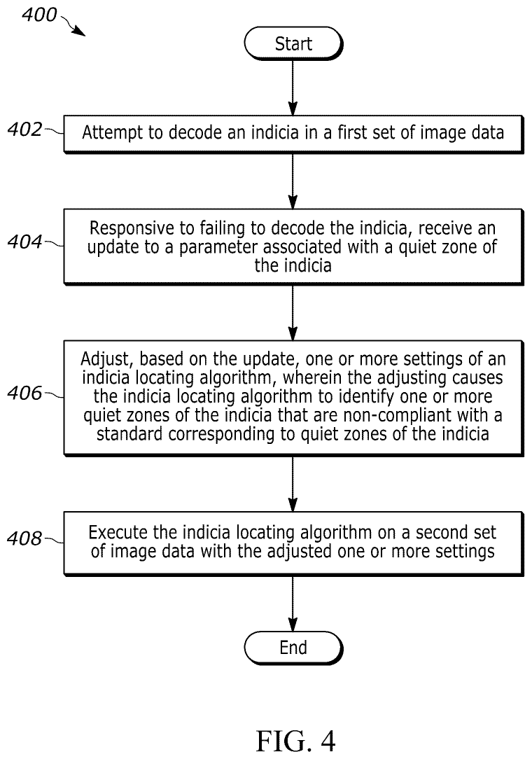

FIG. 4 is a second flowchart representative of a method 400 for decoding indicia, in accordance with embodiments described herein. It is to be understood that any of the steps of the method 400 may be performed by, for example, the scanning device 102, and/or any other suitable components, components contained therein, and/or combinations thereof discussed herein.

At block 402 the method 400 includes attempting to decode an indicia in a first set of image data. The method 400 further includes, responsive to failing to decode the indicia, receiving an update to a parameter associated with a quiet zone of the indicia (block 404). The method 400 further includes adjusting, based on the update, one or more settings of an indicia locating algorithm (block 406). The adjusting may cause the indicia locating algorithm to identify one or more quiet zones of the indicia that are non-compliant with a standard corresponding to quiet zones of the indicia. The method 400 further includes executing the indicia locating algorithm on a second set of image data with the adjusted one or more settings (block 408).

In some embodiments, the method 400 further includes attempting to decode an indicia in a first set of image data; responsive to failing to decode the indicia, receiving an update to a parameter associated with a quiet zone of the indicia; adjusting, based on the update, one or more settings of an indicia locating algorithm, wherein the adjusting causes the indicia locating algorithm to identify one or more quiet zones of the indicia that are non-compliant with a standard corresponding to quiet zones of the indicia; and executing the indicia locating algorithm on a second set of image data with the adjusted one or more settings.

In some embodiments, the method 400 further includes successfully decoding the indicia based on executing the indicia locating algorithm on the second set of image data; and responsive to successfully decoding the indicia, automatically re-adjusting the one or more settings of the indicia locating algorithm to identify quiet zones that are compliant with the standard.

In some embodiments, the parameter has a first value corresponding to quiet zones of a first size, a second value corresponding to quiet zones of a second size that is different from the first size.

In some embodiments, the first size is compliant with a standard quiet zone size indicated by the standard, the second size is non-compliant with the standard quiet zone size, and the update indicates a change of the parameter from the first value to the second value.

In some embodiments, the parameter has a third value corresponding to quiet zones of a third size that is different from the first size and the second size, and the method 400 further includes: successfully decoding the indicia based on executing the indicia locating algorithm on the second set of image data; and responsive to successfully decoding the indicia, receiving a second update to the parameter indicating a change of the parameter from the second value to the third value, wherein the third size is larger than the first size and the second size.

In some embodiments, the first set of image data is identical to the second set of image data.

In some embodiments, the one or more settings are associated with at least one of: (i) a step size, (ii) a maximum change value of the step size, (iii) subsampled image data usage, (iv) zoomed image data usage, (v) subpixel analysis, and/or (vi) an intensity threshold.

In some embodiments, receiving the update to the parameter further includes (i) receiving, from a host device, the update to the parameter upon connection to a network to which the host device is connected; or (ii) receiving a third set of image data representing a second indicia; and receiving the update to the parameter based on decoding the second indicia.

In some embodiments, the one or more quiet zones of the indicia have a dimension of less than four modules.

In some embodiments, the standard is one of: (i) ISO/IEC 15420, (ii) ISO/IEC 18004, (iii) ISO/IEC 16022, (iv) ISO/IEC 24734, (v) ISO/IEC 24778, (vi) AIMD-DC-2014, (vii) AIMD-014-2008, (viii) ISO/IEC 16023, or (ix) ISO/IEC 20830.

In some embodiments, the indicia locating algorithm is a contour walker algorithm, and the method 400 further includes executing, based on automatically generated additional points within the first set of image data, the contour walker algorithm to define one or more bounding edges within the first set of image data; and determining a first boundary within the first set of image data from the one or more bounding edges based on one or more heuristics including: (i) bounding edge corner placement, (ii) bounding edge length, or (iii) bounding edge perpendicularity.

In some embodiments, the method 400 further includes responsive to failing to decode the indicia, generating a parameter adjustment recommendation indicating a recommended adjustment to the parameter; and displaying the parameter adjustment recommendation on a user interface for viewing by a user.

Of course, it is to be appreciated that the actions of the method 400 may be performed any suitable number of times, and that the actions described in reference to the method 400 may be performed in any suitable order.

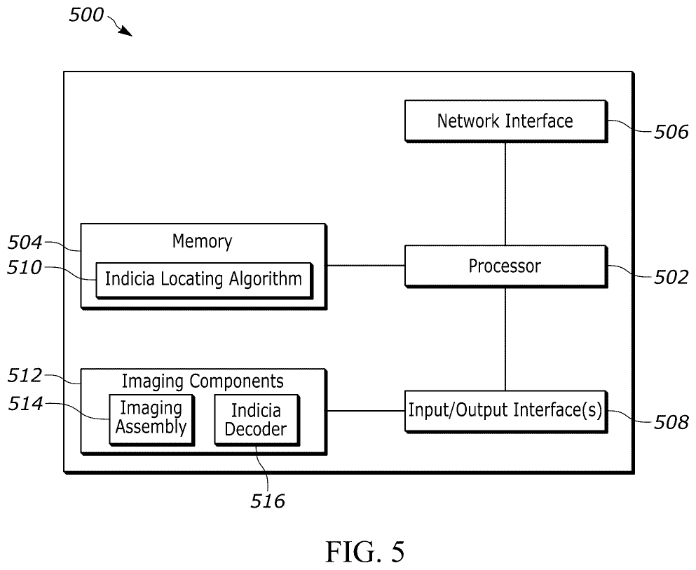

FIG. 5 is a block diagram representative of an example logic circuit capable of implementing, for example, the example scanning device 104 of FIG. 1. The example logic circuit of FIG. 5 is a processing platform 500 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 500 of FIG. 5 includes a processor 502 such as, for example, one or more microprocessors, controllers, and/or any suitable type of processor. The example processing platform 500 of FIG. 5 includes memory (e.g., volatile memory, non-volatile memory) 504 accessible by the processor 502 (e.g., via a memory controller). The example processor 502 interacts with the memory 504 to obtain, for example, machine-readable instructions stored in the memory 504 corresponding to, for example, the operations represented by the flowchart(s) of this disclosure. Additionally, or alternatively, machine-readable instructions corresponding to the example operations described herein may be stored on one or more removable media (e.g., a compact disc (CD), a digital versatile disc (DVD), removable flash memory, etc.) that may be coupled to the processing platform 500 to provide access to the machine-readable instructions stored thereon.

The example processing platform 500 of FIG. 5 includes one or more communication interfaces such as, for example, one or more network interfaces 506, and/or one or more input/output (I/O) interfaces 508. The communication interface(s) may enable the processing platform 500 of FIG. 5 to communicate with, for example, another device, system, host system (e.g., an inventory management system, a POS station, etc.), datastore, database, and/or any other machine.

The example processing platform 500 of FIG. 5 may include the network interface(s) 506 to enable communication with other machines (e.g., an inventory management system, a POS station, etc.) via, for example, one or more networks. The example network interface(s) 506 include any suitable type of communication interface(s) (e.g., wired and/or wireless interfaces) configured to operate in accordance with any suitable communication protocol(s). Example network interfaces 506 include a TCP/IP interface, a Wi-Fi™ transceiver (e.g., according to the IEEE 802.11x family of standards), an Ethernet transceiver, a cellular network radio, a satellite network radio, or any other suitable interface based on any other suitable communication protocols or standards.

The example, processing platform 500 of FIG. 5 may include the input/output (I/O) interface(s) 508 (e.g., a Bluetooth® interface, a near-field communication (NFC) interface, a universal serial bus (USB) interface, a serial interface, an infrared interface, etc.) to (1) enable receipt of user input (e.g., a touch screen, keyboard, mouse, touch pad, joystick, trackball, microphone, button, etc.), (2) communicate output data (e.g., parameter/setting update confirmations, visual indicators, instructions, data, images, etc.) to the user (e.g., via an audio output device, speaker, printer, haptic device, etc.), and/or (3) interact with other components of the processing platform 500 (e.g., a set of imaging components 512, etc.).

To memory 504 stores an indicia locating algorithm 510, which may enable performance of various indicia location/detection functionalities described herein. For example, the processor 502 may access the memory 504 to execute the indicia locating algorithm 510. When the processor 502 receives image data that may represent an indicia, the indicia locating algorithm 510 may cause the processor 502 to analyze the image data and determine whether any indicia are detected within the image data.

To capture images of objects and/or indicia (e.g., barcodes) on objects, the example processing platform 500 includes the set of imaging components 512. The set of imaging components 512 includes the imaging assembly 514 under control of, for example, the processor 502 to capture image frames representative of the portion of an environment in which the example imaging device 102 is operating that falls within an imaging field of view (FOV) of the set of imaging components 512. The imaging assembly 514 may include a plurality of photosensitive elements. The processor 502 may be communicatively coupled to the set of imaging components 512 via the input/output (I/O) interface(s) 508.

The example set of imaging components 512 may also include any number and/or type(s) indicia decoders 516 to decode indicia detected as a result of the indicia locating algorithm 510 to determine the payload of the indicia. In some aspects, the indicia decoder 516 is implemented by the processor 502. The indicia decoder 516, e.g., via the processor 502, conveys the payload of decoded indicia to a host system (e.g., host device 102) via a communication interface such as the network interface(s) 506 and/or the I/O interface(s) 508.

Of course, it should be appreciated that, while the various components of the example processing platform 500 (e.g., processors 502, memory 504, etc.) are illustrated in FIG. 5 as single components, the example processing platform 500 may include multiple of each of the components.

### Additional Considerations

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for decoding indicia, comprising:
attempting to decode an indicia in a first set of image data;
responsive to failing to decode the indicia, receiving an update to a parameter associated with a quiet zone of the indicia;
adjusting, based on the update, one or more settings of an indicia locating algorithm, wherein the adjusting causes the indicia locating algorithm to identify one or more quiet zones of the indicia that are non-compliant with a standard corresponding to quiet zones of the indicia; and
executing the indicia locating algorithm on a second set of image data with the adjusted one or more settings.

2. The method of claim 1, further comprising:
successfully decoding the indicia based on executing the indicia locating algorithm on the second set of image data; and
responsive to successfully decoding the indicia, automatically re-adjusting the one or more settings of the indicia locating algorithm to identify quiet zones that are compliant with the standard.

3. The method of claim 1, wherein the parameter has a first value corresponding to quiet zones of a first size, a second value corresponding to quiet zones of a second size that is different from the first size.

4. The method of claim 3, wherein the first size is compliant with a standard quiet zone size indicated by the standard, the second size is non-compliant with the standard quiet zone size, and the update indicates a change of the parameter from the first value to the second value.

5. The method of claim 3, wherein the parameter has a third value corresponding to quiet zones of a third size that is different from the first size and the second size, and the method further comprises:
successfully decoding the indicia based on executing the indicia locating algorithm on the second set of image data; and
responsive to successfully decoding the indicia, receiving a second update to the parameter indicating a change of the parameter from the second value to the third value, wherein the third size is larger than the first size and the second size.

6. The method of claim 1, wherein the first set of image data is identical to the second set of image data.

7. The method of claim 1, wherein the one or more settings are associated with at least one of: (i) a step size, (ii) a maximum change value of the step size, (iii) subsampled image data usage, (iv) zoomed image data usage, (v) subpixel analysis, or (vi) an intensity threshold.

8. The method of claim 1, wherein receiving the update to the parameter further comprises:
(i) receiving, from a host device, the update to the parameter upon connection to a network to which the host device is connected; or
(ii) receiving a third set of image data representing a second indicia; and
receiving the update to the parameter based on decoding the second indicia.

9. The method of claim 1, wherein the one or more quiet zones of the indicia have a dimension of less than four modules.

10. The method of claim 1, wherein the standard is one of: (i) ISO/IEC 15420, (ii) ISO/IEC 18004, (iii) ISO/IEC 16022, (iv) ISO/IEC 24734, (v) ISO/IEC 24778, (vi) AIMD-DC-2014, (vii) AIMD-014-2008, (viii) ISO/IEC 16023, or (ix) ISO/IEC 20830.

11. The method of claim 1, wherein the indicia locating algorithm is a contour walker algorithm, and the method further comprises:
executing, based on automatically generated additional points within the first set of image data, the contour walker algorithm to define one or more bounding edges within the first set of image data; and
determining a first boundary within the first set of image data from the one or more bounding edges based on one or more heuristics comprising: (i) bounding edge corner placement, (ii) bounding edge length, or (iii) bounding edge perpendicularity.

12. The method of claim 1, further comprising:
responsive to failing to decode the indicia, generating a parameter adjustment recommendation indicating a recommended adjustment to the parameter; and
displaying the parameter adjustment recommendation on a user interface for viewing by a user.

13. A system for improving indicia decoding performance, comprising:
one or more processors; and
one or more memories communicatively coupled to the one or more processors, the one or more memories storing instructions thereon that, when executed by the one or more processors, cause the system to:
attempt to decode an indicia within image data based on a first boundary identified by an indicia locating algorithm;
responsive to failing to decode the indicia, receive an update to a parameter associated with quiet zones of the indicia;
adjust, based on the update, one or more settings of the indicia locating algorithm, wherein the adjusting causes the indicia locating algorithm to identify one or more quiet zones of the indicia that are non-compliant with a standard corresponding to the quiet zones of the indicia; and
execute the indicia locating algorithm on the image data with the adjusted one or more settings to identify a second boundary that is different from the first boundary.

14. The system of claim 13, wherein the instructions, when executed, further cause the system to:
successfully decode the indicia based on the second boundary identified by the indicia locating algorithm; and
responsive to successfully decoding the indicia, automatically re-adjust the one or more settings of the indicia locating algorithm to identify quiet zones that are compliant with the standard corresponding to the indicia.

15. The system of claim 13, wherein the parameter has a first value corresponding to quiet zones of a first size and a second value corresponding to quiet zones of a second size that is different from the first size, the first size is compliant with a standard quiet zone size indicated by the standard, the second size is non-compliant with the standard quiet zone size, and the update indicates a change of the parameter from the first value to the second value.

16. The system of claim 15, wherein the parameter has a third value corresponding to quiet zones of a third size that is different from the first size and the second size.

17. The system of claim 16, wherein the instructions, when executed, further cause the system to:
successfully decode the indicia based on the second boundary identified by the indicia locating algorithm; and
responsive to successfully decoding the indicia, receive a second update to the parameter indicating a change of the parameter from the second value to the third value, wherein the third size is larger than the first size and the second size.

18. The system of claim 13, wherein the one or more settings are associated with at least one of: (i) a step size, (ii) a maximum change value of the step size, (iii) subsampled image data usage, (iv) zoomed image data usage, (v) subpixel analysis, or (vi) an intensity threshold.

19. The system of claim 13, wherein the indicia locating algorithm is a contour walker algorithm, and the instructions, when executed, further cause the system to:
execute, based on automatically generated additional points within the image data, the contour walker algorithm to define one or more bounding edges within the image data; and
determine the first boundary from the one or more bounding edges based on one or more heuristics comprising: (i) bounding edge corner placement, (ii) bounding edge length, or (iii) bounding edge perpendicularity.

20. A tangible machine-readable medium comprising instructions that, when executed, cause a machine to at least:
attempt to decode an indicia within image data based on a first boundary identified by an indicia locating algorithm;
responsive to failing to decode the indicia, receive an update to a parameter associated with quiet zones of the indicia;
adjust, based on the update, one or more settings of the indicia locating algorithm, wherein the adjusting causes the indicia locating algorithm to identify one or more quiet zones of the indicia that are non-compliant with a standard corresponding to the quiet zones of the indicia; and
execute the indicia locating algorithm on the image data with the adjusted one or more settings to identify a second boundary that is different from the first boundary.
